(19) United States
(12) Patent Application Publication
(10) Pub. No.: US 2004/0060332 A1
(43) Pub. Date: Apr. 1, 2004

(54) Lock having a curved keyway and an accompanying key and methods therefor

(75) Inventor: Chien-Kuo Liu, Taipei (TW)

Correspondence Address: BAKER & McKENZIE, c/o Ya-Chiao Chang, 29th Floor, 805 Third Avenue, New York, NY, 10022, US

(73) Assignee: GoldContinent Inventech International Corp.

(21) Appl. No.: 10/264,088

(22) Filed: Oct. 1, 2002

(51) Int. Cl. E05B 19/12

(52) U.S. Cl. 70/409; 70/396; 70/399

(57) ABSTRACT

The present invention advantageously provides a key that poses tremendous difficulty for a lock breaker by not allowing the lock breaker to see all of the pin tumblers in the keyway. The keyway according to a preferred embodiment of the present invention comprises a curvature such that one cannot see the end of the keyway. The present invention further comprises a key having flexibility for fitting into the keyway having a curvature to turn the plug and open the lock.

### BACKGROUND OF THE INVENTION

1. Field of the Invention

The present invention generally relates to a lock and an accompanying curved key and, more specifically, a lock having a curved keyway and an accompanying key with sufficient flexibility to fit into the keyway to turn the key core.

2. Description of the Related Art

The prior art presents a number of cylinder locks with one or more sets of pin tumblers and pin tumbler bores situated next to a key slot formed in a straight line parallel to the direction of key insertion. FIG. 2 is a cross-sectional view through the center of a cylinder lock in the prior art but showing the cylinder plug itself in profile. FIG. 1 is a cross-sectional view taken along the line 1-1 of FIG. 2 of a lock in the prior art.

U.S. Pat. No. 1,961,586 describes a key and lock construction of a plug and a single set of pin-tumblers. U.S. Pat. Nos. 4,434,636 and 4,638,651 describe cylinder locks with two sets of tumblers. In the prior art, the pin tumblers are mostly situated above a straight key slot and works along the profile of the upper edge of a straight key. Alternatively, an additional set of pin tumbler may be located at the bottom or side of similar key slot and works along the profile at the bottom or side of the key.

The customary practice of breaking a lock, or opening a lock without its key, is to look through the key slot or keyway, with the aid of a special eye piece, and insert into the keyway a rod to joggle the pin tumblers so that the meeting line between the pin tumblers and its drivers (meeting line), on top of the pin tumblers, coincides with the circumference of the cylinder plug to thereby turn the plug, as illustrated in conjunction with FIG. 1. Alternatively, without viewing, the lock breaker can joggle the pin tumblers by feeling or sensing the pin tumblers with the rod and turning the plug simultaneously so that the meeting line coincides with the circumference of the cylinder plug allowing the lock to be opened. No matter how many sets of pin tumblers there are in the lock, an experienced lock breaker can often successfully joggle the pin tumblers to turn the plug as long as he can see or feel all of the pin tumblers in the keyway. FIG. 3 is a schematic view depicting the manner in which a lock-opening rod functions in a lock in the prior art. Thus, the ability to see and joggle with all the pin tumblers in the keyway is the essence of lock breaking or opening a lock without its key. Once one can see all the pin tumblers in the keyway, one is likely to break almost any lock.

There is thus a general need in the art for a lock with enhanced security that overcomes at least the aforementioned shortcomings in the art. In particular, there is a need in the art for a key that poses tremendous difficulty for a lock breaker by not allowing the lock breaker to see all of the pin tumblers in the keyway.

### SUMMARY OF THE INVENTION

The enhancement of lock security has been a long-felt need. The present invention advantageously provides a key that poses tremendous difficulty for a lock breaker by not allowing the lock breaker to see all of the pin tumblers in the keyway. Furthermore, the curvature of the keyway of the lock of the present invention prevents the rod from successfully engaging the pin tumblers. The keyway according to a preferred embodiment of the present invention comprises a curvature such that one cannot see the end of the keyway. The present invention further comprises a key having flexibility for fitting into the keyway having a curvature to turn the plug and open the lock.

Another embodiment of the present invention further provides a lock comprising a housing having a cylindrical opening, a lock core situated inside the opening and formed with a curved keyway, and pin tumbler bores, receiving pin tumblers, situated next to the keyway.

Yet another embodiment of the present invention further provides a key comprising a head, a bar having sufficient flexibility to fit into a lock core having a curved keyway, and a surface contour, on the bar, complementary to the pin tumblers.

Yet another embodiment of the present invention further provides a corresponding method of opening a lock, comprising the steps of procuring a flexible key, inserting the key into a curved keyway, and turning the key.

Yet another embodiment of the present invention further provides, in combination, a key comprising a head and a bar, the bar being flexible and having an outer contour complementary to pin tumblers; and lock cylinder receiving the key comprising a housing having a cylindrical opening, a lock core, in the opening, formed with a curved keyway receiving the bar of the key, the core and the housing being provided with the pin tumblers and pin tumbler bores next to the keyway, the pin tumblers engaging the contour on the outer surface of the key to thereby allow the core to turn within the housing.

Yet another embodiment of the present invention further provides a locking device comprising a lock core further comprising a curved keyway. In the locking device according to this particular embodiment of the invention, the curved keyway further comprises a curvature wherein the keyway cannot be viewed in its entirety from outside the keyway. The curved keyway according to the invention can further comprise a curvature wherein an end of the keyway cannot be viewed from outside the keyway. The curved keyway can further comprise a curvature having a shape of a sine wave. Moreover, the curved keyway can further comprise a curvature having a shape of at least a portion of a single period of a sine wave. In addition, the locking device according to a further embodiment of the invention further comprises a lock. The lock according to this further embodiment of the invention can further comprise a housing having a cylindrical opening. Moreover, the lock can further comprise a housing having a cylindrical opening in which the lock core is situated, and pin tumbler bores, receiving pin tumblers, generally situated next to the keyway. In this locking device according to the invention, all of the pin tumblers cannot be viewed from outside the keyway. Furthermore, the pin tumbler bores can be situated at random locations around the keyway. The locking device according to another embodiment of the invention further comprises a key. The key can further comprise a head, a bar having sufficient flexibility to fit into a lock core having a curved keyway, and a surface contour on the bar. The bar according to this particular embodiment of the invention can further comprise a plurality of linkages with a clearance of tolerance in between the linkages. Moreover, the locking device according to the invention can further comprise a pin through a hole spanning extension and recess portions of two of the linkages and holding the two linkages together. The locking device according to the invention can further comprise a key having a head, a bar fitting into the curved keyway and engaging the pin tumblers, and a surface contour, on the bar, complementary to the pin tumblers. The locking device according to another embodiment of the invention can further comprise a plurality of curve humps blocking viewing of the keyway in its entirety from outside the keyway. The bar according to the invention can be made of a material comprising metal, plastic and latex. The lock core can be made by fusing filling materials to a curved channel all around to form a core. Alternatively, one can die-cast right and left halves of the lock core and fuse the two halves together to form the lock core. Moreover, the lock core is bored with hardened steel pins.

### BRIEF DESCRIPTION OF THE DRAWINGS

The foregoing features and advantages of the invention will become more apparent in the following Detailed Description when read in conjunction with the accompanying drawings (not necessarily drawn to scale), in which:

FIG. 1 is a cross-sectional view taken along the line 1-1 of FIG. 2 of a lock in the prior art;

FIG. 2 is a cross-sectional view through the center of a cylinder lock in the prior art but showing the cylinder plug itself in profile;

FIG. 3 is a schematic view depicting the manner in which a lock-opening rod functions in a lock in the prior art;

FIG. 4 is a cross-sectional view through the center of the shell of a preferred embodiment of the lock according to the present invention but showing the cylinder core itself in profile;

FIG. 5 is a schematic view of another preferred embodiment of the accompanying curved key of the lock according to the present invention;

FIG. 5A is a top view of a typical linkage contained in the key bar of the key according to the invention as illustrated in conjunction with FIG. 5;

FIG. 6 is a schematic view depicting the inside of the curved keyway in different directions according to another embodiment of the present invention; and

FIG. 7 is a schematic view depicting the inside of another curved keyway in different directions according to yet another embodiment of the present invention.

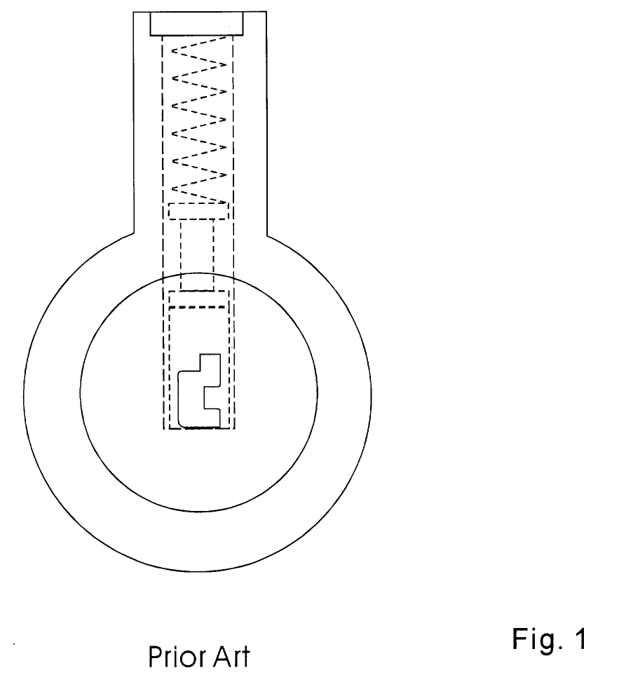

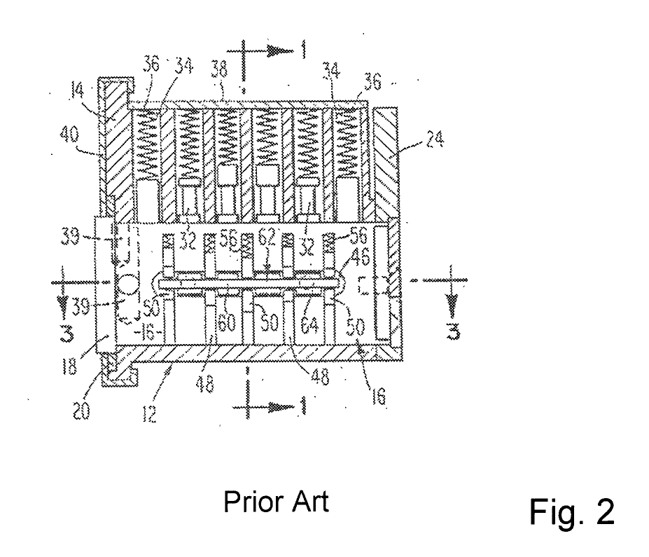

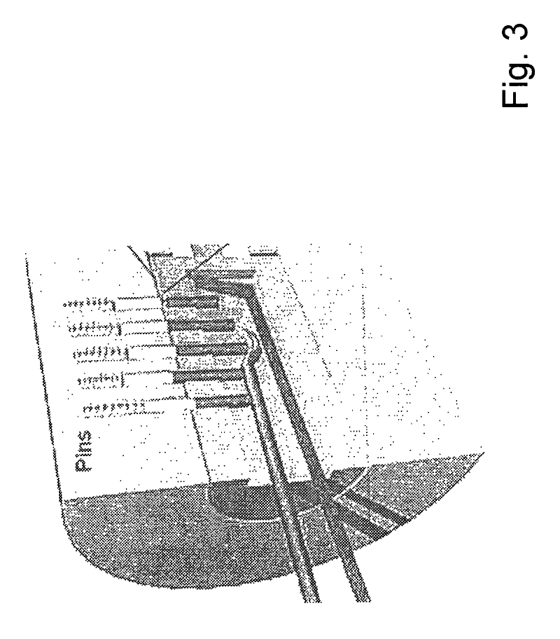

### DETAILED DESCRIPTION OF PREFERRED EMBODIMENTS

The present invention embodies a lock comprising a housing or shell, whereas the shell may take various shapes such as a cylinder lock shell, a mortise lock shell, a rim lock shell, or a core.

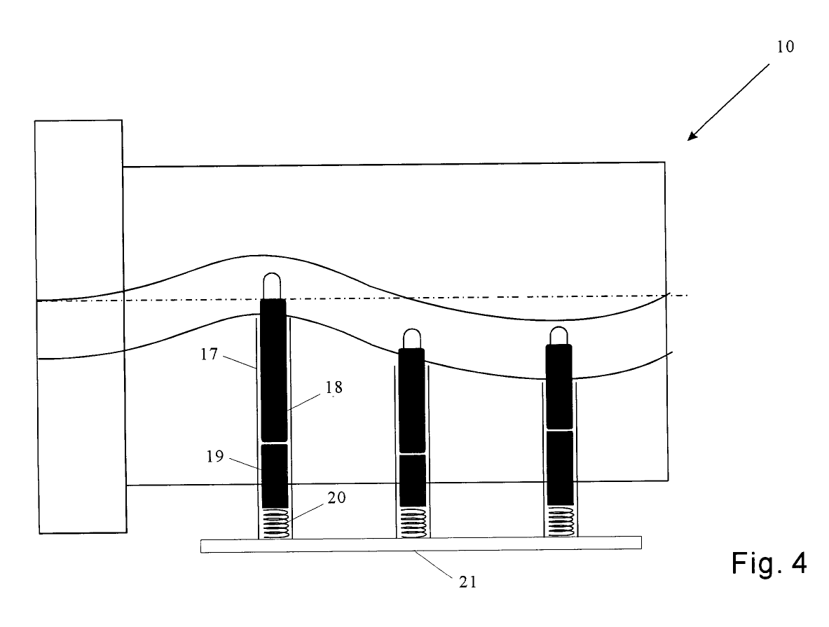

The lock core is rotatably disposed inside the housing. Formed in the core is a curved keyway. The curved keyway is curved in a manner so that one cannot see through the entire keyway, i.e. one is unable to see all of the pin tumblers. Alternatively, the keyway is so curved so that one cannot see the end of the keyway. FIG. 4 is a cross-sectional view through the center of the shell of a preferred embodiment of the lock according to the present invention but showing the cylinder core itself in profile. In a preferred embodiment of the present invention, the keyway has a curvature that is of a relaxed S shape or of the form of a sine wave, which embodiment is illustrated in the cross-sectional view in FIG. 4 and generally designated 10. In a viewing direction 11 or 12, one cannot see the end 13 of the curved keyway 14. An anterior hump 15 or posterior hump 16 blocks one's view through the entire keyway. Pin tumbler bores 17 are situated at the bottom of the keyway. Alternatively, the tumbler bores may be situated next to the keyway at any location around the keyway. The tumbler bores receive the pin tumblers 18, the lower end of which engages the drivers 19. The drivers are urged upward by a spring 20. A plate 21 holds down the lower ends of the springs.

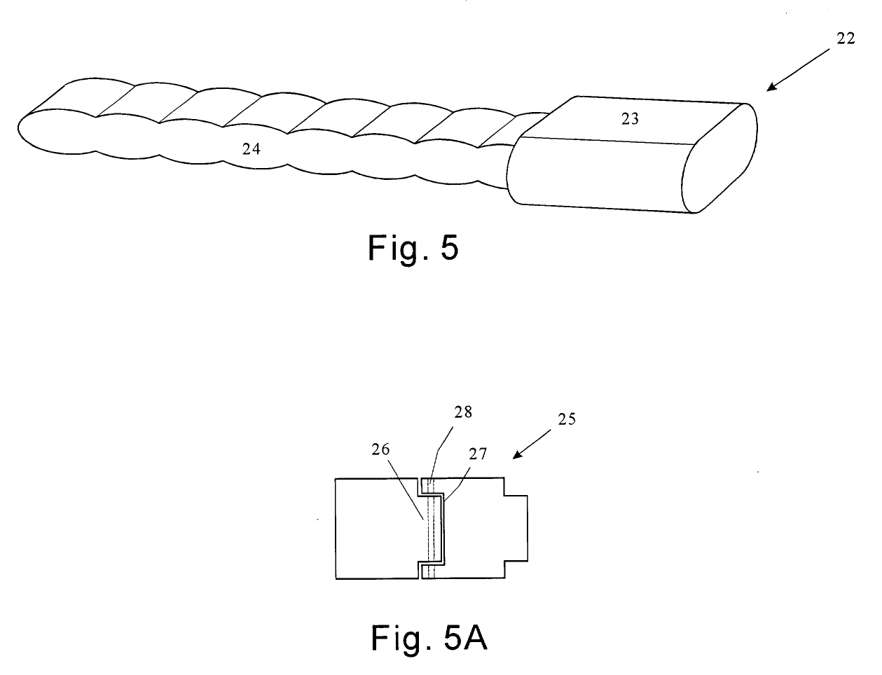

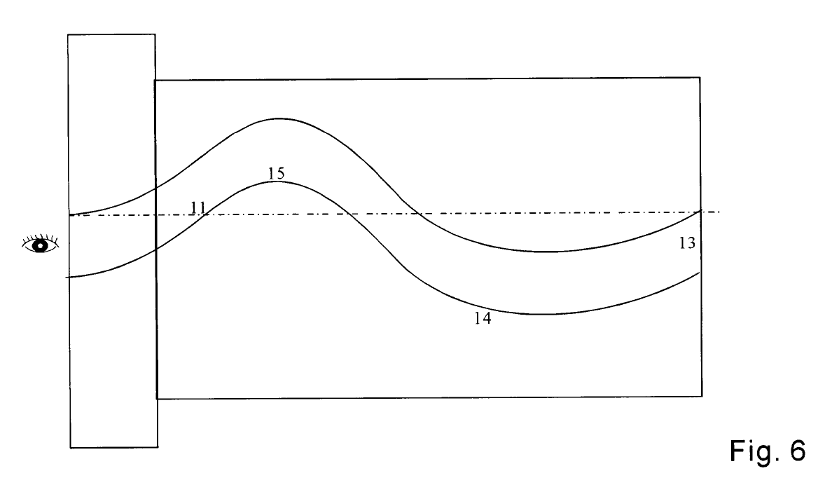

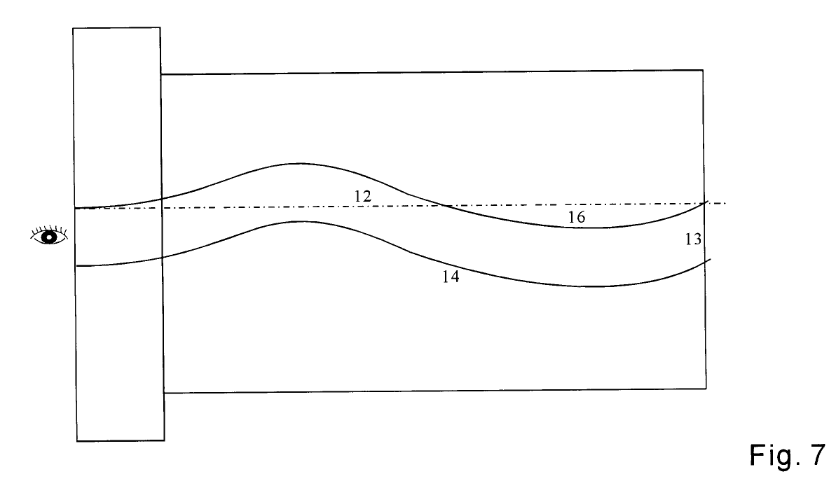

FIG. 5 is a schematic view of another preferred embodiment of the accompanying curved key of the lock according to the present invention. The key according to another embodiment of the present lock invention is illustrated in FIG. 5 and generally designated 22. The key 22 comprises the head 23 and the bar 24. The bar is formed with certain flexibility so that it can fit into the keyway and engage the pin tumblers, such as a bar made out of strong latex or similar material that confers flexibility on the bar. Alternatively, in a preferred embodiment, the bar is formed with pieces of material (e.g., metal, plastic, or latex), or linkages, linked together, generally designated 25. A single linkage is linked to the next linkage in the manner that the extension portion 26 of one linkage and the recess portion 27 of another linkage are fit together with a clearance of certain tolerance in between so that the bar is flexible enough to fit inside the curved keyway and engage the pin tumblers. A pin 28 going through a hole spanning the extension and recess portions of the two linkages holds the linkages together. The outer surface of the linkages is formed with a pin tumbler-engaging contour. The tumbler-engaging contour can be on any face of the outer surface, e.g., upper, lower, right, left, right lower, left upper, and is complementary to the pin-tumblers to allow exertion of force to move the pin tumblers and thereby turn the plug. Each linkage of the bar may be of the same size and shape or of different size and shape.

The lock of the present invention comprises a core and a shell. The core formed with a curved keyway and pin tumbler bores next to the keyway can be made by methods such as fusing filling materials to a curved channel all around to form the core or fusing two left and right halves of die-casted core to form the core. The core with the assembled pin tumblers in the pin tumbler bores can then be fit into the shell by methods such as boring the core with hardened steel pins and holding the core inside with a ring shield, which together help to thwart the drilling the cylinder core out of the lock. The front end of the cylinder shell may be covered by a sheath of decorative metal.

The key of the present invention can be made by methods conferring sufficient flexibility on the key, and thereby allowing the key to be inserted into the keyway to engage the pin tumblers. One can die-cast the key with materials that are known to confer flexibility such as latex or plastics. The material shall be chosen so that the desired degree of flexibility in the key is achieved to enable the key to fit wholly into the key slot and engage the pin tumblers to turn the plug. Alternatively, in a preferred embodiment, the key may be made of linkages, i.e. pieces of materials made from a group comprising metals, plastic or latex. The linkages are linked together by a pin going through a thorough hole between the linkages. Two pieces of linkages are put together by fitting the extension portion of one linkage with the recess portion of another linkage. The fit allows for a clearance, within certain tolerance range, in between the linkages, which tolerance range allows the key to be inserted wholly into the key slot to engage the pin tumblers to turn the plug. The pin is used to hold the two linkages together in the manner with the desired clearance. One can die-cast the linkages with the materials recited above or materials with similar properties. The pins can be made from the same material as that of the linkages or similar material.

The key of the present invention is inserted into the keyway completely. Then, the contour profile of the key works against all of the pin tumblers to determine the respective meeting lines so that when the meeting line between the pin tumblers and the drivers coincide with the circumference of the plug, the plug may be turned.

Another embodiment of the present invention further provides a corresponding method of opening a lock, comprising the steps of procuring a flexible key, inserting the key into a curved keyway, and turning the key.

Yet another embodiment of the present invention further provides, in combination, a key comprising a head and a bar, the bar being flexible and having an outer contour complementary to pin tumblers; and lock cylinder receiving the key comprising a housing having a cylindrical opening, a lock core, in the opening, formed with a curved keyway receiving the bar of the key, the core and the housing being provided with the pin tumblers and pin tumbler bores next to the keyway, the pin tumblers engaging the contour on the outer surface of the key to thereby allow the core to turn within the housing.

Yet another embodiment of the present invention further provides a locking device comprising a lock core further comprising a curved keyway. In the locking device according to this particular embodiment of the invention, the curved keyway further comprises a curvature wherein the keyway cannot be viewed in its entirety from outside the keyway. The curved keyway according to the invention can further comprise a curvature wherein an end of the keyway cannot be viewed from outside the keyway. The curved keyway can further comprise a curvature having a shape of a sine wave. Moreover, the curved keyway can further comprise a curvature having a shape of at least a portion of a single period of a sine wave. In addition, the locking device according to a further embodiment of the invention further comprises a lock. The lock according to this further embodiment of the invention can further comprise a housing having a cylindrical opening. Moreover, the lock can further comprise a housing having a cylindrical opening in which the lock core is situated, and pin tumbler bores, receiving pin tumblers, generally situated next to the keyway. In this locking device according to the invention, all of the pin tumblers cannot be viewed from outside the keyway. Furthermore, the pin tumbler bores can be situated at random locations around the keyway. The locking device according to another embodiment of the invention further comprises a key. The key can further comprise a head, a bar having sufficient flexibility to fit into a lock core having a curved keyway, and a surface contour on the bar. The bar according to this particular embodiment of the invention can further comprise a plurality of linkages with a clearance of tolerance in between the linkages. Moreover, the locking device according to the invention can further comprise a pin through a hole spanning extension and recess portions of two of the linkages and holding the two linkages together. The locking device according to the invention can further comprise a key having a head, a bar fitting into the curved keyway and engaging the pin tumblers, and a surface contour, on the bar, complementary to the pin tumblers. The locking device according to another embodiment of the invention can further comprise a plurality of curve humps blocking viewing of the keyway in its entirety from outside the keyway. The bar according to the invention can be made of a material comprising metal, plastic and latex. The lock core can also be made by fusing filling materials, e.g., metals, plastics or similar materials, to a curved channel all around to form a core containing the curved channel inside, or by any other methods that can form a keyway inside the lock core. Moreover, the lock core is bored with hardened steel pins.

Without the curved key according to the invention, a lock breaker is unable to open the lock because the conventional lock breaking rod cannot be used in the lock of the present invention where the keyway is curved. Furthermore, even with the use of a flexible rod that can curve along the keyway, the lock breaker is still unable to joggle the pin tumblers to the right place as he cannot see all of the pin tumblers due to the curved path of the keyway. One is unable to view the entire keyway as the view would be blocked by the curve humps. Even in the case of joggling the pin tumblers by sensing, without viewing, the pin tumblers with a rod, and one is able to feel all of the pin tumblers in the curved keyway, the curvature of the keyway will restrict the curvature and movement of the rod. Such restriction will prevent the meeting line from coinciding with the circumference of the cylinder plug, and the lock can not be opened. For example, when a flexible rod is shoved into the curved keyway, the keyway curvature causes the rod to be so curved that the rod pushes the first tumbler so that its meeting line is pushed up beyond the circumference of the cylinder plug. The same problem applies to all subsequent pin tumblers. As long as one tumbler's meeting line fails to coincide with the circumference of the cylinder plug, the lock can not be opened. The keyway curvature poses tremendous difficulty for lock breaker to joggle the pin tumblers by sight or by feel. Thus, the present invention is a fundamental improvement in enhancing the security of a lock.

It would be apparent to one skilled in the art that the invention can be embodied in various ways and implemented in many variations. Such variations are not to be regarded as a departure from the spirit and scope of the invention. In particular, the process steps of the method according to the invention will include methods having substantially the same process steps as the method of the invention to achieve substantially the same results. Substitutions and modifications have been suggested in the foregoing Detailed Description, and others will occur to one of ordinary skill in the art. All such modifications as would be obvious to one skilled in the art are intended to be included within the scope of the following claims and their equivalents.

What is claimed is:

1. A lock core comprising a curved keyway.

2. The lock core of claim 1, the curved keyway further comprising a curvature wherein the keyway cannot be viewed in its entirety from outside the keyway.

3. The lock core of claim 1, the curved keyway further comprising a curvature wherein an end of the keyway cannot be viewed from outside the keyway.

4. The lock core of claim 1, the curved keyway further comprising a curvature having a shape of a sine wave.

5. The lock core of claim 1, the curved keyway further comprising a curvature having a shape of at least a portion of a single period of a sine wave.

6. A lock comprising:
(a) a housing having a cylindrical opening;
(b) a lock core situated inside the opening and formed with a curved keyway; and
(c) pin tumbler bores, receiving pin tumblers, generally situated next to the keyway.

7. The lock of claim 6, wherein the pin tumbler bores are generally situated at random locations around the keyway.

8. A key comprising:
(a) a head
(b) a bar having sufficient flexibility to fit into a lock core having a curved keyway;
(c) a surface contour on the bar.

9. The key of claim 8, the bar further comprising linkages with a clearance of tolerance in between the linkages.

10. In combination, a key comprising a head and a bar, the bar being flexible and having an outer contour complementary to pin tumblers; and lock cylinder receiving the key comprising a housing having a cylindrical opening, a lock core, in the opening, formed with a curved keyway receiving the bar of the key, the core and the housing being provided with the pin tumblers and pin tumbler bores next to the keyway, the pin tumblers engaging the contour on the outer surface of the key for allowing the core to turn within the housing.

11. A locking device comprising:
a lock core further comprising a curved keyway.

12. The locking device of claim 11, the curved keyway further comprising a curvature wherein the keyway cannot be viewed in its entirety from outside the keyway.

13. The locking device of claim 11, the curved keyway further comprising a curvature wherein an end of the keyway cannot be viewed from outside the keyway.

14. The locking device of claim 11, the curved keyway further comprising a curvature having a shape of a sine wave.

15. The locking device of claim 11, the curved keyway further comprising a curvature having a shape of at least a portion of a single period of a sine wave.

16. The locking device of claim 11 further comprising a lock.

17. The locking device of claim 16, the lock further comprising a housing having a cylindrical opening.

18. The locking device of claim 16, the lock further comprising:
a housing having a cylindrical opening in which the lock core is situated; and pin tumbler bores, receiving pin tumblers, generally situated next to the keyway.

19. The locking device of claim 18 wherein all of the pin tumblers cannot be viewed from outside the keyway.

20. The locking device of claim 18, wherein the pin tumbler bores are generally situated at random locations around the keyway.

21. The locking device of claim 11 further comprising a key.

22. The locking device of claim 11 further comprising a key, wherein the key further comprises:
a head;
a bar having sufficient flexibility to fit into a lock core having a curved keyway; and
a surface contour on the bar.

23. The locking device of claim 22, the bar further comprising linkages with a clearance of tolerance in between the linkages.

24. The locking device of claim 23, further comprising a pin through a hole spanning extension and recess portions of two of the linkages and holding the two linkages together.

25. The locking device of claim 22 wherein the bar is made of a material comprising metal, plastic and latex.

26. The locking device of claim 18, further comprising a key, wherein the key further comprises:
a head;
a bar fitting into the curved keyway and engaging the pin tumblers; and
a surface contour, on the bar, complementary to the pin tumblers.

27. The locking device of claim 11 wherein the lock core is made by die-casting.

28. The locking device of claim 11, further comprising a curved channel wherein filling materials are fused to the curved channel in forming a core.

29. The locking device of claim 11 wherein the lock core is bored with hardened steel pins.

30. The locking device of claim 11, further comprising a plurality of curve humps blocking viewing of the keyway in its entirety from outside the keyway.

31. A method of opening a lock, comprising the steps of:
(a) procuring a flexible key;
(b) inserting the key into a curved keyway; and
(c) turning the key.
